(19) United States
(12) Patent Application Publication
(10) Pub. No.: US 2024/0261835 A1
(43) Pub. Date: Aug. 8, 2024

(54) METHOD FOR EFFICIENT DISPOSAL OF DIOXIN AND HEAVY METALS BASED ON CALCIUM-BASED HEAT STORAGE OF MSWI FLY ASH

(71) Applicant: Zhejiang University, Hangzhou (CN)

(72) Inventors: Xiaoqing Lin, Hangzhou (CN); Jie Chen, Hangzhou (CN); Hong Yu, Hangzhou (CN); Xiaodong Li, Hangzhou (CN); Jianhua Yan, Hangzhou (CN)

(21) Appl. No.: 18/518,418

(22) Filed: Nov. 22, 2023

(30) Foreign Application Priority Data
Feb. 1, 2023 (CN) 202310050776.3

(51) Int. Cl. B09B 3/70; B09B 3/35; B09B 3/40

(52) U.S. Cl. CPC B09B 3/70; B09B 3/35; B09B 3/40; B09B 2101/30

(57) ABSTRACT

A method for efficient disposal of dioxin and heavy metals based on calcium-based heat storage of MSWI fly ash is provided. According to the method, MSWI fly ash washed with water is treated with ammonia, and carbon dioxide is continuously introduced under stirring. The ammonia provides OH⁻ for a carbonation reaction of the MSWI fly ash and promotes removal of sulfate ions. After centrifugation of a reaction solution, calcium carbonate obtained as a solid part is transported to a calcinator of a solar chemical heat reservoir and calcined into calcium oxide by means of solar energy obtained by a solar concentrator. CO₂ produced in a calcination process is collected, cooled and liquefied, followed by a carbonation reaction with the calcium oxide in a carbonation radiator. After the operations above are repeated in cycles for several times, carbonated MSWI fly ash is obtained for use as an aggregate or a filler.

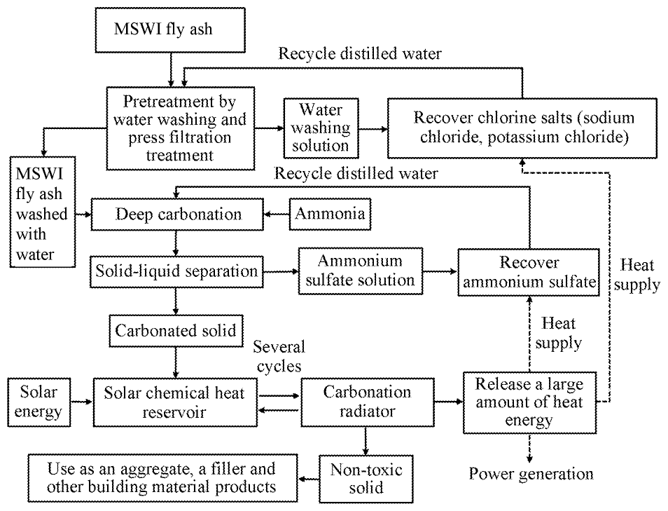

### CROSS-REFERENCE TO RELATED APPLICATION

The present application claims priority from Chinese Patent Application No. 202310050776.3 filed on Feb. 1, 2023, the contents of which are incorporated herein by reference in their entirety.

### TECHNICAL FIELD

The present disclosure relates to a solid waste treatment technology, particularly relates to a method for efficient disposal of dioxin and heavy metals based on calcium-based heat storage of municipal solid waste incineration (MSWI) fly ash, and belongs to the technical field of harmless disposal of MSWI fly ash.

### BACKGROUND

As MSWI fly ash contains heavy metals, dioxin and other toxic pollutants, MSWI fly ash has been classified as hazardous waste. Therefore, harmless disposal of the MSWI fly ash mainly includes stabilization/solidification of the heavy metals and removal or degradation of the dioxin. At present, disposal technologies of MSWI fly ash include a melting and vitrification method, a sintering method, a low-temperature pyrolysis method, a mechanochemical method, a cement solidification method, a chemical stabilization method, a biological/chemical extraction method and the like. The low-temperature pyrolysis method and the mechanochemical method have high efficiency in removal and degradation of the dioxin, but have a poor solidification effect on the heavy metals. All the cement solidification method, the chemical stabilization method and the biological/chemical extraction method can realize effective removal or stabilization/solidification of the heavy metals, but the dioxin is still contained in the MSWI fly ash. The melting and vitrification method and the sintering method can solve the problem of effective and simultaneous disposal of the heavy metals and the dioxin, but the problem of secondary MSWI fly ash is likely to be caused, and energy consumption is high. In addition, as the MSWI fly ash contains large amounts of chlorine salts and calcium hydroxide, these substances have resource utilization potential after proper separation and utilization.

A Chinese invention patent “Technology for Reduction Treatment of Waste Incineration Fly Ash by Fractional Calcination” (CN104070053B) introduces a method for removal of heavy metals and chlorine salts by completely degrading dioxin and promoting volatilization of large amounts of heavy metals and chlorine salts at a high temperature of 1,250° C. under the action of a dechlorination flux. The MSWI fly ash is further sintered, stabilized and solidified after secondary calcination. The method has the disadvantages that high corrosion of the chlorine salts to equipment is inevitable, the disposal cost is high, a large amount of heat is consumed, and carbon emissions are increased. A Chinese invention patent “Method for Collaborative Treatment of Municipal Solid Waste Incineration Fly Ash through Copper Smelting” (CN108517418A) introduces a method for smelting copper by adding MSWI fly ash into a copper concentrate in a certain proportion. However, as melting is performed at a temperature of 1,250-1,350° C., large amounts of heavy metals are volatilized with secondary ash, leading to secondary pollution. In addition, due to the addition of the MSWI fly ash, the copper smelting efficiency is also affected, and energy consumption is increased.

Through the above technical conditions, it can be seen that the current technologies for the harmless disposal of MSWI fly ash have many defects. Therefore, it is necessary to provide a method for harmless disposal of MSWI fly ash that has the advantages of energy conservation, a green effect, environmental friendliness, and low carbon emissions and solves the problem of pollution caused by heavy metals and dioxin simultaneously.

### SUMMARY

The technical problems to be solved by the present disclosure are to overcome the disadvantages of the prior art and provide a method for efficient disposal of dioxin and heavy metals based on calcium-based heat storage of MSWI fly ash.

In order to solve the technical problems, the following technical schemes are adopted by the present disclosure.

A method for efficient disposal of dioxin and heavy metals based on calcium-based heat storage of MSWI fly ash is provided. The method includes the following steps:
(1) subjecting MSWI fly ash to pretreatment by water washing, and subjecting a mixed suspension obtained after the water washing to solid-liquid separation to obtain MSWI fly ash washed with water as a solid part and a water washing solution as a liquid part;
(2) with the mass of the MSWI fly ash washed with water as a reference, taking water and ammonia at a liquid-solid ratio of (5-10):1 and (1-2):1 (L/kg), respectively, adding the ammonia after uniformly mixing the water with the MSWI fly ash washed with water, and then performing magnetic stirring for 10-30 minutes to obtain a mixture solution;
(3) continuously introducing carbon dioxide into the mixture solution by bubbling under stirring conditions, where the ammonia provides OH for a carbonation reaction of the MSWI fly ash and promotes removal of sulfate ions; monitoring changes of the concentration of the sulfate ions in a reaction solution, and stopping bubbling when the concentration is not increased; subjecting the reaction solution to centrifugation to obtain an ammonium sulfate solution as a supernatant and calcium carbonate as a solid part; and drying the calcium carbonate;
(4) transporting the calcium carbonate solid to a calcinator of a solar chemical heat reservoir, performing calcination at a temperature of 900-1,000° C. for 2-6 hours by means of solar energy obtained by a solar concentrator, obtaining a remaining calcined solid with calcium oxide as a main component, and collecting carbon dioxide produced during the calcination into a storage tank for cooling and liquefaction, where heavy metals such as arsenic and selenium are volatilized during the calcination due to low melting points and then cooled and liquefied with the carbon dioxide;
(5) transporting the calcined solid to a carbonation radiator after ball milling, introducing the carbon dioxide in the storage tank into the carbonation radiator to carry out a carbonation reaction at a pressure of 0.5-2 MPa and a temperature of 600-900° C., and obtaining solid calcium carbonate, where heat energy released in the reaction process is used for power generation; and
(6) repeating step (4) and step (5) in cycles for a total of 5-10 times, and finally, collecting a solid in the carbonation radiator, where the solid contains calcium carbonate as a main component and can be used as an aggregate or a filler.

As a preferred scheme of the present disclosure, in step (1), the pretreatment by water washing is performed at a liquid-solid ratio of (3-5):1 (L/kg) for 60 minutes; the magnetic stirring is performed continuously at a rotation speed of 1,000 r/min during the water washing; the solid-liquid separation is performed by press filtration or centrifugation; the MSWI fly ash washed with water contains calcium hydroxide, calcium carbonate, calcium sulfate, silicon dioxide and alumina; and the water washing solution contains sodium chloride and potassium chloride.

As a preferred scheme of the present disclosure, in step (1), the water washing solution is transported to a steam mechanical recompression evaporator to recover chlorine salts, and distilled water is recycled; and in step (3), the ammonium sulfate solution is transported to the steam mechanical recompression evaporator to recover ammonium sulfate, and the distilled water is recycled.

As a preferred scheme of the present disclosure, in step (2), the ammonia is industrial ammonia with a mass fraction of 25%; and the magnetic stirring is performed at a rate of 200-600 r/min.

As a preferred scheme of the present disclosure, in step (3), the carbon dioxide is introduced at a rate of 200 mL/min; and the stirring is performed magnetically at a rate of 500 r/min.

As a preferred scheme of the present disclosure, in step (3), the solid obtained after the centrifugation is placed in a drying oven and dried at 100-110° C. for 12-24 hours to obtain solid calcium carbonate, and then the solid calcium carbonate is transported to the storage tank for later use.

As a preferred scheme of the present disclosure, in step (4), the solar chemical heat reservoir includes the calcinator supplied with heat by the solar concentrator, and the temperature in the calcinator is controlled by changing the angle and quantity of the solar concentrator.

As a preferred scheme of the present disclosure, in step (5), the carbonation radiator includes a high pressure gas-solid reaction furnace connected to a heat exchange device, and the volume of the added solid is 10%-20% of that of the reaction furnace.

As a preferred scheme of the present disclosure, in step (5), the calcined solid is transported to a roller type ball mill, the mass ratio of ball milling materials is set to (3-5):1, the ball milling is performed at a rotation speed of 10-20 r/min for 1-2 hours, and the solid obtained after the ball milling is transported to the storage tank; the calcined solid has a particle size of 2 microns or below after the ball milling; and the solid obtained after first calcination contains the calcium oxide as a main component, 5%-10% of silicon dioxide and alumina.

As a preferred scheme of the present disclosure, in step (6), the finally collected solid contains calcium carbonate as a main component, 3%-6% of silicon dioxide and alumina.

### Principles of the Present Disclosure are Described as Follows

1. Existing MSWI fly ash carbonation disposal technologies mainly include capturing carbon dioxide by calcium hydroxide in MSWI fly ash so as to prepare calcium carbonate. However, obtained carbonated MSWI fly ash contains a small amount of calcium carbonate and a large amount of calcium sulfate. When the carbonated MSWI fly ash prepared by methods in the prior art is used for solar thermochemical heat storage in the present disclosure, the calcium sulfate is prone to a thermal sintering phenomenon with calcium oxide, silicates and salts containing phosphorus, chlorine and fluorine in the MSWI fly ash to produce a sintered mineral Ca₅(P, Si, S)₃O₁₂(Cl, OH, F). In this case, the sintered MSWI fly ash is free of a carbonation ability, and captured heat energy cannot be released in the form of a gas-solid carbonation reaction. In addition, the MSWI fly ash contains large amounts of chlorine salts. Although the large amounts of chlorine salts can be removed by a carbonation reaction of the MSWI fly ash, the MSWI fly ash still contains 3%-5% of chlorine salts. On the one hand, sintered products are formed by these chlorine salts during high-temperature calcination of the carbonated MSWI fly ash; and on the other hand, these chlorine salts are volatilized at high temperature to corrode calcination equipment, thereby greatly increasing the equipment maintenance cost.

In order to overcome the above defects of the prior art, in the present disclosure, firstly, original MSWI fly ash is subjected to pretreatment by water washing first to remove most of soluble chlorine salts. Then, a carbonation reaction of the MSWI fly ash is adjusted by adding ammonia into a carbonation reaction system, so that the calcium sulfate in the MSWI fly ash is efficiently converted into calcium carbonate, and further dechlorination is realized. Then, a carbonated solid product is used for solar thermochemical heat storage, and calcium oxide partially inactivated in a calcination process is activated by mechanical ball milling, so that high carbonation heat release efficiency is achieved. Energy consumption of a MSWI fly ash disposal system is reduced, and a final product is harmless and has high resource utilization potential. Specific technical principles are as follows:

### (1) Dechlorination of MSWI Fly Ash by Water Washing:

Large amounts of soluble chlorine salts (such as sodium chloride and potassium chloride) in MSWI fly ash are removed by water washing, and the sodium chloride and the potassium chloride contained in a water washing solution are recovered by distillation. After the water washing, the MSWI fly ash contains large amounts of calcium hydroxide, calcium sulfate, calcium carbonate, silicon dioxide and other slightly soluble or insoluble substances, where the content of the calcium hydroxide and the calcium sulfate is 80% or above, and raw materials are provided for preparation of calcium carbonate.

### (2) High-Efficiency Carbonation and Deep Desulfurization and Dechlorination Mechanisms:

In the present disclosure, carbonation and desulfurization of the MSWI fly ash are adjusted by an appropriate amount of ammonia. On the one hand, the ammonia can achieve an effective capturing effect on carbon dioxide and increase the concentration of carbonates in a liquid phase reaction system, thereby increasing the carbonation rate of the MSWI fly ash. Mainly involved chemical reactions (1-5) are as follows.

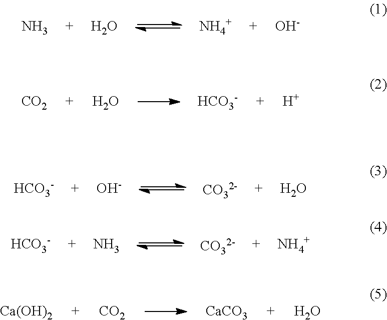

On the other hand, the ammonia can provide hydroxide ions and provide reaction conditions for carbonation of the calcium sulfate, the calcium sulfate is converted into calcium carbonate, and sulfate ions are removed. A mainly involved chemical reaction (6) is as follows.

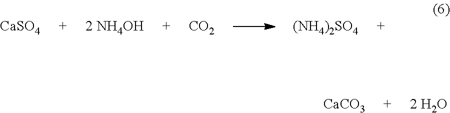

Large amounts of soluble chlorine salts are eluted in a water washing process, and small amounts of insoluble chlorine salts (Friedel salts) remaining in the MSWI fly ash are converted into soluble chloride salts in a deep carbonation process and removed with chloride ions. In addition, the amount of the ammonia added is required to be adjusted to an appropriate range, and a good effect is not achieved by using a large amount of the ammonia. The release of heavy metals is affected by the ammonia in a carbonation process of the MSWI fly ash. When the amount of the ammonia added is too large, a reaction system has too high alkalinity, and accordingly, the release amount of most of heavy metals (such as As, Cu, Ni, Pb and Zn) is greatly increased, which exceeds a sewage discharge standard (GB 8978). After the carbonation reaction process adjusted by the ammonia, the content of calcium carbonate in a solid product is 80% or above, the content of the calcium sulfate is less than 0.5%, and the content of chlorine is less than 0.5%, so that a material composition basis is provided for a subsequent thermochemical heat storage cycle of the calcium carbonate.

### (3) Thermochemical Heat Storage and Release Mechanism of Carbonated MSWI Fly Ash:

According to a chemical reaction equation (7) and the prior art, it can be seen that the calcium carbonate is considered as an ideal thermochemical heat storage material.

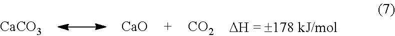

According to the principle (2), the carbonated MSWI fly ash prepared by the present disclosure has a calcium carbonate content of 80% and has a higher thermochemical heat storage density than the carbonated MSWI fly ash prepared by the existing MSWI fly ash carbonation technologies. The calcium sulfate and the chloride salts are prone to a sintering phenomenon with the calcium oxide to produce a sintered mineral Ca₅(P, Si, S)₃O₁₂(Cl, OH, F) at high temperature, thereby reducing the content of the calcium oxide and the carbonation activity. In the present disclosure, the occurrence of the sintering phenomenon can be avoided by deep desulfurization and dechlorination, so that the heat release efficiency of the carbonated MSWI fly ash after calcination is significantly improved. In addition, the carbonated MSWI fly ash prepared by the present disclosure contains 5%-10% of silicon dioxide and alumina, which can improve sintering conditions of the calcium oxide, reduce the inactivation rate of the calcium oxide and improve the multi-cycle carbonation activity of the calcium oxide. In order to improve the carbonation heat release efficiency of a calcined product as much as possible, the carbonated MSWI fly ash after calcination is also subjected to mechanical ball milling treatment in the present disclosure. A small amount of the sintered calcium oxide is reactivated, the particle size of the calcium oxide is decreased, and the specific surface area is increased, so that the carbonation activity is improved to a maximum extent, and more heat is released in a heat release stage.

As for the solar concentrator of the present disclosure, sunlight is focused on the solar thermochemical heat reservoir through a disc type concentrator to provide heat for the solar thermochemical heat reservoir, and the thermochemical heat reservoir absorbs a large amount of heat to perform thermal decomposition on the calcium carbonate in the carbonated MSWI fly ash. By changing the angle and quantity of the solar concentrator, the calcination temperature of the solar chemical heat reservoir can be adjusted to 900-1,000° C. The calcium carbonate is fully decomposed into calcium oxide at this temperature. Then, the carbonated MSWI fly ash after calcination is subjected to mechanical ball milling. Mechanical ball milling equipment is connected to a carbonation radiator. A solid obtained after the ball milling is transported to the carbonation radiator, and the carbonation radiator is connected to a carbon dioxide storage tank. The solid obtained after the ball milling is subjected to a gas-solid carbonation reaction of the calcium oxide and carbon dioxide by adjusting the carbon dioxide pressure in the radiator. A large amount of heat released by the carbonation reaction is transferred to a heat exchange device connected to the carbonation radiator. Output heat can be supplied to the entire MSWI fly ash disposal system, and remaining heat is used for power generation and also supplied to the MSWI fly ash disposal system. In the present disclosure, the solar thermochemical heat reservoir, the solar concentrator, the carbonation radiator and other devices are devices in the prior art, and operation principles and connection modes of the devices can refer to the paper “Efficient Capture and Absorption of CaCO3 Series Based on Solar Thermal Storage” and contents disclosed at the website https://www.cnpowder.com.cn/news/62867.html.

### (4) Dioxin Degradation and Heavy Metal Stabilization/Solidification Mechanisms:

By means of the method of the present disclosure, dioxin in the MSWI fly ash can be fully degraded at 900-1,000° C. (dioxin molecules are decomposed at a temperature of greater than 800° C.) under the premise of thermochemical heat storage and carbonation heat release of the carbonated MSWI fly ash. In addition, a large amount of chlorine in the MSWI fly ash is removed by the water washing and the deep carbonation reaction, so that the possibility of synthesis of the dioxin in an initial stage is avoided. After several cycles, the degradation rate of the dioxin is 99.9% or above.

In a high-temperature calcination stage, As and Se with low boiling points are enriched with a carbon dioxide flow in a carbon dioxide storage tank due to volatilization (the volatilization rate is 99% or above), and the remaining heavy metals are not volatilized at 900-1,000° C. and usually exist in the form of oxides after calcination. After a gas-solid carbonation heat release reaction, most of the non-volatilized heavy metals (such as Cu, Ni, Pb and Zn) are converted into stable carbonate forms to achieve a chemical stabilization effect. At high temperature, the calcium carbonate is sintered to a certain extent to form a stable and compact calcite structure, and the heavy metals are embedded into the calcite structure to achieve an efficient physical encapsulation effect. In addition, silicate solid solutions are also formed by the silicon dioxide, the alumina and the heavy metals to a certain extent in a high-temperature calcination process. Therefore, the heavy metals are efficiently stabilized/solidified under the combined action of chemical stabilization, physical encapsulation and formation of solid solutions.
2. Based on the above principles, calcium-containing components in the MSWI fly ash, especially calcium sulfate that is easily ignored in the prior art, are efficiently converted into calcium carbonate by bubbling of carbon dioxide in the present disclosure, and the carbon dioxide is efficiently captured. Soluble chlorine salts, insoluble chlorine salts and calcium sulfate are obtained by fractional removal, and high-purity chloride salts and ammonium sulfate are recovered. The prepared carbonated MSWI fly ash has a calcium carbonate content of higher than 80% and extremely low contents of calcium sulfate and chlorine salts. Therefore, the carbonated MSWI fly ash prepared by the present disclosure can be used for thermochemical heat storage and carbonation heat release to provide energy for a MSWI fly ash disposal system. In addition, after several cycles of thermochemical heat storage and carbonation heat release, the heavy metals in the carbonated MSWI fly ash are efficiently stabilized/solidified, the dioxin is completely degraded, and resulting calcium carbonate as a main component has high resource utilization potential.
   Compared with the Prior Art, the Present Disclosure has the Following Advantages:
(1) By means of the method of the present disclosure, carbon dioxide can be permanently stored, calcium in the MSWI fly ash is used to a maximum extent, and the carbon capture ability of the MSWI fly ash is improved.
(2) According to the method of the present disclosure, high-purity chlorine salts and ammonium sulfate are obtained by fractional recovery without producing waste liquid in the whole process.
(3) According to the method of the present disclosure, thermochemical heat storage of solar energy is realized by the pretreated MSWI fly ash, the heat storage efficiency is 80% or above, and energy consumption of a MSWI fly ash disposal system is reduced by 90% or above.
(4) The method of the present disclosure can realize efficient solidification of heavy metals in the MSWI fly ash and collaborative degradation of dioxin.
(5) The method of the present disclosure has the advantages of an economical effect, a green effect, energy conservation, environmental friendliness and low carbon emissions.

### BRIEF DESCRIPTION OF THE DRAWINGS

The sole FIGURE is a process flowchart of a method for harmless disposal of MSWI fly ash mentioned in the present disclosure.

### DETAILED DESCRIPTION

The present disclosure is further described below through examples in combination with accompanying drawings, but the present disclosure is not limited thereto.

In each example, MSWI fly ash collected from a waste incineration plant in Zhejiang province was selected. The leaching concentration of heavy metals in the MSWI fly ash based on an HJ/T 557-2010 standard is shown in Table 1, and the toxic equivalent concentration of dioxin is 0.25 ng I-TEQ/g.

### Example 1

As shown in the sole FIGURE, a MSWI fly ash disposal process in this example specifically includes the following steps.
(1) MSWI fly ash was subjected to pretreatment by water washing, where the liquid-solid ratio was set to 3:1 (L/kg), and magnetic stirring was performed at a rotating speed of 1,000 r/min for 60 minutes during the water washing. A mixed suspension obtained after the water washing was subjected to solid-liquid separation by press filtration to obtain MSWI fly ash washed with water as a solid part and a water washing solution as a liquid part. The MSWI fly ash washed with water contained calcium hydroxide, calcium carbonate, calcium sulfate, silicon dioxide and alumina, and the water washing solution contained sodium chloride and potassium chloride. The water washing solution was transported to a steam mechanical recompression evaporator to recover chlorine salts, and distilled water was recycled.
(2) Water was added into the MSWI fly ash washed with water at a liquid-solid ratio of 5:1 (L/kg) to obtain a mixture solution, and ammonia was added into the mixture solution at a liquid-solid (ammonia-MSWI fly ash) ratio of 1:1 (L/kg), where industrial ammonia with a mass fraction of 25% was selected. Magnetic stirring was performed at a rate of 200 r/min for 10 minutes to obtain a mixed solution of MSWI fly ash and ammonia after uniform mixing.
(3) 200 mL/min of carbon dioxide was continuously introduced into the mixed solution of MSWI fly ash and ammonia by bubbling, magnetic stirring was continuously performed at a rate of 500 r/min, the concentration of sulfate ions in a reaction solution was monitored, the bubbling was stopped when the concentration of sulfate ions was not increased, and then the reaction solution was subjected to centrifugation. An ammonium sulfate solution obtained in a supernatant was transported to the steam mechanical recompression evaporator to recover ammonium sulfate, and the distilled water was recycled. A remaining solid was placed in a drying oven and dried at 100° C. for 24 hours, and the dried solid was transported to a calcium carbonate storage tank.
(4) The dried solid in the calcium carbonate storage tank was transported to a solar chemical heat reservoir, and a large amount of heat was provided for decomposition of calcium carbonate by a solar concentrator. Calcination was performed at a temperature of 900° C. for 6 hours, and resulting carbon dioxide was collected in a carbon dioxide storage tank for cooling and liquefaction. Heavy metals such as arsenic and selenium with low melting points and a volatilization rate of 99% or above in the MSWI fly ash were transported to the carbon dioxide storage tank with the carbon dioxide for cooling and liquefaction. The calcined solid was transported to a roller type ball mill, where the mass ratio of ball milling materials was set to 3:1, ball milling was performed at a rotation speed of 20 r/min for 1 hour, the solid obtained after the ball milling had a particle size of 2 microns or below, and the solid obtained after first calcination contained calcium oxide as a main component, 5% of silicon dioxide and alumina. Then, the solid obtained after the ball milling was transported to a calcium oxide storage tank.
(5) The solid obtained after the ball milling in the calcium oxide storage tank was transported to a carbonation radiator, where the volume of the solid obtained after the ball milling was 10% of that of the carbonation radiator. The carbon dioxide in the carbon dioxide storage tank was introduced into the carbonation radiator to carry out a carbonation reaction in the carbonation radiator at a carbon dioxide pressure of 0.5 MPa and a temperature of 600° C. Then, a carbonated solid was transported to the calcium carbonate storage tank, where heat energy released during the carbonation reaction was used for power generation.
(6) Step (4) and step (5) were repeated for cycles for a total of 5 times, and finally, a resulting solid in the carbonation radiator was collected, where the solid contained calcium carbonate as a main component, 3% of silicon dioxide and alumina and could be used for secondary use as a green non-toxic aggregate or filler.

A heavy metal leaching test was carried out on the final product based on the HJ/T 557-2010 standard. The leaching toxicity of heavy metals is greatly reduced, and leaching results are as shown in Table 1 (ND indicates not detected).

TABLE 1
Leaching concentration of heavy metals in original MSWI
fly ash and a final product in Example 1 (mg/L)

| Heavy metal element | As | Ba | Cd | Cr | Ni | Cu | Pb | Se | Zn |
|---|---|---|---|---|---|---|---|---|---|
| Original MSWI fly ash | 0.25 | 3.24 | 0.27 | 0.91 | 0.65 | 1.18 | 9.89 | 0.32 | 2.75 |
| MSWI fly ash disposal | ND | 0.01 | ND | 0.05 | ND | 0.02 | ND | ND | ND |
| product in Example 1 | | | | | | | | | |

Dioxin concentration test: As the concentration of dioxin in the final product after disposal is not detected, the degradation rate of dioxin reaches 100% after disposal in the present disclosure.

### Example 2

MSWI fly ash selected in this example was the same as that in Example 1. Except that some parameters were adjusted as follows, other operation processes were consistent with those in Example 1.
(1) The liquid-solid ratio was set to 4:1 (L/kg) during pretreatment of the MSWI fly ash by water washing, and solid-liquid separation was performed by centrifugation.
(2) Water was added into the MSWI fly ash washed with water at a liquid-solid ratio of 7.5:1 (L/kg) to obtain a mixture solution, ammonia was added into the mixture solution at a liquid-solid (ammonia-MSWI fly ash) ratio of 1.5:1 (L/kg), and magnetic stirring was performed at a rate of 400 r/min for 20 minutes.
(3) Drying was performed in a drying oven at a temperature of 105° C. for 18 hours.
(4) Calcination was performed at a temperature of 950° C. for 4 hours. The mass ratio of ball milling materials in a roller type ball mill was set to 4:1, and ball milling was performed at a rotation speed of 15 r/min for 1.5 hours. A solid obtained after first calcination contained calcium oxide as a main component, 7.5% of silicon dioxide and alumina.
(5) The volume of a solid obtained after the ball milling was 15% of that of a carbonation radiator. The carbon dioxide pressure in the carbonation radiator was set at 1.25 MPa, and the reaction temperature was set at 750° C.
(6) Step (4) and step (5) were repeated for cycles for a total of 7 times, and finally, a resulting solid product contained calcium carbonate as a main component, 4.5% of silicon dioxide and alumina.

A heavy metal leaching test was carried out on the final MSWI fly ash disposal product based on the HJ/T 557-2010 standard. The leaching toxicity of heavy metals is greatly reduced, and leaching results are as shown in Table 2 (ND indicates not detected).

TABLE 2
Leaching concentration of heavy metals in original MSWI
fly ash and a final product in Example 2 (mg/L)

| Heavy metal element | As | Ba | Cd | Cr | Ni | Cu | Pb | Se | Zn |
|---|---|---|---|---|---|---|---|---|---|
| Original MSWI fly ash | 0.25 | 3.24 | 0.27 | 0.91 | 0.65 | 1.18 | 9.89 | 0.32 | 2.75 |
| MSWI fly ash disposal | ND | 0.01 | 0.01 | 0.09 | ND | ND | ND | ND | ND |
| product in Example 2 | | | | | | | | | |

Dioxin concentration test: As the concentration of dioxin in the final product after disposal is not detected, the degradation rate of dioxin reaches 100% after disposal in the present disclosure.

### Example 3

MSWI fly ash selected in this example was the same as that in Example 1. Except that some parameters were adjusted as follows, other operation processes were consistent with those in Example 1.
(1) The liquid-solid ratio was set to 5:1 (L/kg) during pretreatment of the MSWI fly ash by water washing, and solid-liquid separation was performed by press filtration.
(2) Water was added into the MSWI fly ash washed with water at a liquid-solid ratio of 10:1 (L/kg) to obtain a mixture solution, ammonia was added into the mixture solution at a liquid-solid (ammonia-MSWI fly ash) ratio of 2:1 (L/kg), and magnetic stirring was performed at a rate of 600 r/min for 30 minutes.
(3) Drying was performed in a drying oven at a temperature of 110° C. for 12 hours.
(4) Calcination was performed at a temperature of 1,000° C. for 2 hours. The mass ratio of ball milling materials in a roller type ball mill was set to 5:1, and ball milling was performed at a rotation speed of 10 r/min for 2 hours. A solid obtained after first calcination contained calcium oxide as a main component, 10% of silicon dioxide and alumina.
(5) The volume of a solid obtained after the ball milling was 20% of that of a carbonation radiator. The carbon dioxide pressure in the carbonation radiator was set at 2 MPa, and the reaction temperature was set at 900° C.
(6) Step (4) and step (5) were repeated for cycles for a total of 10 times, and finally, a resulting solid product contained calcium carbonate as a main component, 6% of silicon dioxide and alumina.

A heavy metal leaching test was carried out on the final product based on the HJ/T 557-2010 standard. The leaching toxicity of heavy metals is greatly reduced, and leaching results are as shown in Table 3 (ND indicates not detected).

TABLE 3
Leaching concentration of heavy metals in original MSWI
fly ash and a final product in Example 3 (mg/L)

| Heavy metal element | As | Ba | Cd | Cr | Ni | Cu | Pb | Se | Zn |
|---|---|---|---|---|---|---|---|---|---|
| Original MSWI fly ash | 0.25 | 3.24 | 0.27 | 0.91 | 0.65 | 1.18 | 9.89 | 0.32 | 2.75 |
| MSWI fly ash disposal | ND | 0.12 | ND | 0.09 | 0.18 | ND | 0.01 | ND | ND |
| product in Example 3 | | | | | | | | | |

Dioxin concentration test: As the concentration of dioxin in the final product after disposal is not detected, the degradation rate of dioxin reaches 100% after disposal in the present disclosure.

According to the analysis and test results of each example, it can be seen that after the MSWI fly ash is disposed by the method of the present disclosure, the leaching toxicity of heavy metals in the final product is significantly reduced, which is far lower than the requirements of resource utilization for leaching of heavy metals as stipulated in “Technical Specification for Pollution Control of Fly Ash from Municipal Solid Waste Incineration” (HJ 1134-2020). The dioxin is completely degraded, and the concentration of dioxin is not detected in the final product. Therefore, the method for efficient disposal of dioxin and heavy metals based on calcium-based heat storage of MSWI fly ash provided by the present disclosure has efficient capture and fixing effects and a permanent storage effect on carbon dioxide, efficient solidification and stabilization effects on heavy metals in MSWI fly ash, and a complete degradation effect on dioxin in the MSWI fly ash. In addition, as the carbonated MSWI fly ash is used as a raw material for solar thermochemical heat storage in the disposal process, not only is the purpose of disposal achieved, but also photothermal energy is stored as chemical energy, and energy is provided for a MSWI fly ash disposal system as required. The method of the present disclosure is a technology for resource utilization of MSWI fly ash that has a great practical prospect in engineering application and has the advantages of energy conservation, a green effect, low carbon emissions and environmental friendliness.

Obviously, various subsequent applications, supplements, modifications and alternations of the present disclosure can be made by those skilled in the art without departing from the spirit and scope of the present disclosure. When the various applications, supplements, modifications and alternations made based on the present disclosure fall within the scope of the claims and equivalent technologies thereof of the present disclosure, the present disclosure is also intended to include the applications, supplements, modifications and alternations.

What is claimed is:

1. A method for efficient disposal of dioxin and heavy metals based on calcium-based heat storage of municipal solid waste incineration (MSWI) fly ash, comprising the following steps:
(1) subjecting the MSWI fly ash to pretreatment by water washing, and subjecting a mixed suspension obtained after the water washing to solid-liquid separation to obtain MSWI fly ash washed with water as a solid part and a water washing solution as a liquid part, wherein the water washing solution is transported to a steam mechanical recompression evaporator to recover chlorine salts, and distilled water is recycled;
(2) with the mass of the MSWI fly ash washed with water as a reference, taking water and ammonia at a liquid-solid ratio of (5-10):1 and (1-2):1 (L/kg), respectively, adding the ammonia after uniformly mixing the water with the MSWI fly ash washed with water, and then performing magnetic stirring for 10-30 minutes to obtain a mixture solution;
(3) continuously introducing carbon dioxide into the mixture solution by bubbling under stirring conditions, wherein the ammonia provides OH⁻ for a carbonation reaction of the MSWI fly ash and promotes removal of sulfate ions; monitoring changes of the concentration of the sulfate ions in a reaction solution, and stopping bubbling when the concentration is not increased; subjecting the reaction solution to centrifugation to obtain an ammonium sulfate solution as a supernatant and calcium carbonate as a solid part; and drying the calcium carbonate, wherein the ammonium sulfate solution is transported to the steam mechanical recompression evaporator to recover ammonium sulfate, and the distilled water is recycled;
(4) transporting the calcium carbonate solid to a calcinator of a solar chemical heat reservoir, performing calcination at a temperature of 900-1,000° C. for 2-6 hours by means of solar energy obtained by a solar concentrator, obtaining a remaining calcined solid with calcium oxide as a main component, and collecting carbon dioxide produced during the calcination into a storage tank for cooling and liquefaction, wherein heavy metals such as arsenic and selenium are volatilized during the calcination due to low melting points and then cooled and solidified with the carbon dioxide;
(5) transporting the calcined solid to a carbonation radiator after ball milling, introducing the carbon dioxide in the storage tank into the carbonation radiator to carry out a carbonation reaction at a pressure of 0.5-2 MPa and a temperature of 600-900° C., and obtaining solid calcium carbonate, wherein heat energy released in the reaction process is used for power generation; and
(6) repeating step (4) and step (5) in cycles for a total of 5-10 times, and finally, collecting a solid in the carbonation radiator, wherein the solid contains calcium carbonate as a main component and can be used as an aggregate or a filler.

2. The method according to claim 1, wherein in step (1), the pretreatment by water washing is performed at a liquid-solid ratio of (3-5):1 (L/kg) for 60 minutes; the magnetic stirring is performed continuously at a rotation speed of 1,000 r/min during the water washing; the solid-liquid separation is performed by press filtration or centrifugation; the MSWI fly ash washed with water contains calcium hydroxide, calcium carbonate, calcium sulfate, silicon dioxide and alumina; and the water washing solution contains sodium chloride and potassium chloride.

3. The method according to claim 1, wherein in step (2), the ammonia is industrial ammonia with a mass fraction of 25%; and the magnetic stirring is performed at a rate of 200-600 r/min.

4. The method according to claim 1, wherein in step (3), the carbon dioxide is introduced at a rate of 200 mL/min; and the stirring is performed magnetically at a rate of 500 r/min.

5. The method according to claim 1, wherein in step (3), the solid obtained after the centrifugation is placed in a drying oven and dried at 100-110° C. for 12-24 hours to obtain solid calcium carbonate, and then the solid calcium carbonate is transported to the storage tank for later use.

6. The method according to claim 1, wherein in step (4), the solar chemical heat reservoir comprises the calcinator supplied with heat by the solar concentrator, and the temperature in the calcinator is controlled by changing the angle and quantity of the solar concentrator.

7. The method according to claim 1, wherein in step (5), the carbonation radiator comprises a high pressure gas-solid reaction furnace connected to a heat exchange device, and the volume of the added solid is 10%-20% of that of the reaction furnace.

8. The method according to claim 1, wherein in step (5), the calcined solid is transported to a roller type ball mill, the mass ratio of ball milling materials is set to (3-5):1, the ball milling is performed at a rotation speed of 10-20 r/min for 1-2 hours, and the solid obtained after the ball milling is transported to the storage tank; the calcined solid has a particle size of 2 microns or below after the ball milling; and the solid obtained after first calcination contains the calcium oxide as a main component, 5%-10% of silicon dioxide and alumina.

9. The method according to claim 1, wherein in step (6), the finally collected solid contains calcium carbonate as a main component, 3%-6% of silicon dioxide and alumina.
